(19) United States
(12) Patent Application Publication
(10) Pub. No.: US 2024/0386252 A1
(43) Pub. Date: Nov. 21, 2024

(54) USING AN INTERMEDIATE DATASET TO GENERATE A SYNTHETIC DATASET BASED ON A MODEL DATASET

(71) Applicant: International Business Machines Corporation, Armonk, NY (US)

(72) Inventor: Charles Mackin, San Jose, CA (US)

(21) Appl. No.: 18/318,622

(22) Filed: May 16, 2023

(51) Int. Cl. G06N 3/0475; G06N 3/045; G06N 3/047; G06N 3/084

(52) U.S. Cl. CPC G06N 3/0475; G06N 3/045; G06N 3/047; G06N 3/084

(57) ABSTRACT

Techniques regarding generating a synthetic dataset of objects are provided. For example, one or more embodiments described herein can comprise a system, which can comprise a memory that can store computer executable components. The system can also comprise a processor, operably coupled to the memory, and that can execute the computer executable components stored in the memory. The computer executable components can include a generative component that generates an intermediate dataset comprising an inverse copula network. The system can further include a result component that utilizes the intermediate dataset as input for an inverse marginal CDF network, resulting in a result dataset of objects, with the inverse marginal CDF network being generated based on a model dataset of objects.

### BACKGROUND

One or more embodiments relate to neural networks, and more specifically, to using neural networks to generate synthetic datasets.

### SUMMARY

The following presents a summary to provide a basic understanding of one or more embodiments of the disclosure. This summary is not intended to identify key or critical elements, or to delineate any scope of particular embodiments or any scope of the claims. Its sole purpose is to present concepts in a simplified form as a prelude to the more detailed description that is presented later. In one or more embodiments described herein, systems, computer-implemented methods, apparatuses and/or computer program products that can utilize an intermediate dataset to generate a synthetic dataset based on a model dataset.

According to some embodiments described herein, a system is provided. The system can include a memory that stores computer executable components. The system can also include a processor, operably coupled to the memory, that can execute the computer executable components stored in the memory. The computer executable components can include a generative component that generates an intermediate dataset comprising an inverse copula network. The computer executable components can further include a result component that utilizes the intermediate dataset as input for an inverse marginal cumulative distribution function (CDF) network, resulting in a result dataset of objects, with the inverse marginal CDF network being generated based on a model dataset of objects.

In variations of the system embodiments, the generating the intermediate dataset can include transforming independent uniform noise into correlated uniform noise. In variations of the system embodiments, the inverse marginal cumulative distribution function network was generated based on applying a marginal cumulative distribution function to the model dataset, with the result dataset being generated by applying an inverse of the marginal cumulative distribution function to the intermediate dataset.

In variations of the system embodiments, the inverse marginal CDF network was generated based on applying a marginal CDF to the model dataset, and the result dataset was generated by applying an inverse of the marginal CDF to the intermediate dataset. In variations of the system embodiments, the intermediate dataset can correspond to captured correlations between attributes of the model dataset. In variations of the system embodiments, the result dataset can result from applying the inverse of the marginal CDF to the captured correlations to yield a synthetic dataset that is similar to the model dataset. In variations of the system embodiments, the captured correlations can include a normalized dependence structure of the model dataset. In variations of the system embodiments, the inverse marginal CDF network can correspond to a uniform distribution of captured respective marginal distributions of the model dataset.

In variations of the system embodiments, the result dataset of objects can include a synthetic dataset having a dependence structure and marginal distributions that are similar to the model dataset with a degree of similarity that exceeds a threshold. In variations of the system embodiments, the generative component and the discriminator network can be included in a generative adversarial network (GAN). In variations of the system embodiments, the generative adversarial network can include a Wasserstein generative adversarial network. In variations of the system embodiments, the generative adversarial network can operate by a process that comprises utilizing gradient penalties.

In variations of the system embodiments, the computer executable components can further include an extrapolation component that can modify the inverse marginal CDF network, resulting in a modified inverse marginal cumulative distribution network, with the result component utilizing the intermediate dataset as input for the modified inverse marginal CDF network. Further, based on the result dataset being generated by the modified inverse marginal cumulative distribution network, the result dataset of objects can include synthetic data generated by extrapolation beyond the model dataset of objects. In variations of the system embodiments, the extrapolation component can modify the inverse marginal CDF network based on an association with a different dataset of the objects, and the synthetic data can result from extrapolation from the model dataset to the different dataset.

In variations of the system embodiments, the different dataset can include a non-tail portion of the model dataset and the synthetic data can include extrapolated data that describes a tail portion of the model dataset. In variations of the system embodiments, the inverse marginal cumulative function network and adversarial results of the discriminator network applied to the generator component during generation of the inverse copula network, are backpropagated to the generative component.

According to one or more example embodiments, a computer-implemented method is provided. The computer-implemented method can include generating, by a system operatively coupled to a processor, an inverse copula network that includes an intermediate dataset of objects, with the inverse copula network being generated based on unform noise and a discriminator network that was generated based on a model dataset of the objects. Embodiments may further include, utilizing, by the system, the intermediate dataset as input for an inverse marginal CDF network, resulting in a result dataset of the objects, with the inverse marginal CDF network being generated based on the model dataset.

In different embodiments, the intermediate dataset can correspond to captured correlations between attributes of the model dataset. In different embodiments, the result dataset can result from applying the inverse of the marginal CDF to the captured correlations to yield a synthetic dataset that is similar to the model dataset. In different embodiments, the captured correlations can include a normalized dependence structure of the model dataset.

According to other example embodiments, a computer program product that can generate a synthetic dataset of objects is provided. In embodiments, the computer program product can include a computer readable storage medium having program instructions, with the program instructions executable by a processor to cause the processor to generate an inverse marginal cumulative distribution network for a first dataset of objects. In embodiments, the program instructions can be executable by a processor to cause the processor to generate an inverse copula network. The instructions can further cause the processor to utilize the inverse copula network as input for an inverse marginal CDF network, resulting in a synthetic dataset of objects, with the inverse marginal CDF network being generated based on a model dataset of objects. The instructions further include generating a discriminator network that classifies the synthetic dataset in relation to the model dataset. Further, the instructions include, to improve the classifying, backpropagating, depending on the classification of the result dataset, changes to the inverse copula network and the discriminator network.

In additional or alternative embodiments, the instructions can further include generating the inverse copula network using a first stage of a multi-stage generation process. Further, the second stage of the multi-stage generation process can utilize the inverse copula network as input for an inverse marginal CDF network, resulting in the synthetic dataset of objects, with the inverse marginal CDF network being generated based on a model dataset of objects. In a variation, a generative adversarial network that includes features of embodiments described herein can include a Wasserstein generative adversarial network that utilizes gradient penalties.

Other embodiments may become apparent from the following detailed description when taken in conjunction with the drawings.

### BRIEF DESCRIPTION OF THE DRAWINGS

In certain embodiments, the present invention is described with reference to accompanying color figures. The color figures provided herein are intended to facilitate a clear understanding of the invention and are not intended to limit the scope or functionality of the invention in any way.

FIG. 1 illustrates a block diagram of an example, non-limiting synthetic data system for utilizing an intermediate dataset to generate a synthetic dataset based on a model dataset, in accordance with one or more embodiments described herein.

FIG. 2A illustrates a block diagram of an example, non-limiting system that can utilize alternate implementations of a DNN to generate a synthetic dataset, in accordance with one or more embodiments described herein.

FIG. 2B illustrates a block diagram of an example, non-limiting system that can utilize a two-stage generator operating in a generative adversarial network (GAN), in accordance with one or more embodiments.

FIG. 3 depicts example charts of values associated with a system that utilizes an intermediate dataset to generate a synthetic dataset, in accordance with one or more embodiments described herein.

FIG. 4 depicts a process where a model dataset may be used to generate multiple derived sets of data for performance of different embodiments described herein, in accordance with one or more embodiments.

FIG. 5 depicts an example of an inverse copula network that can result from operation of a first stage of the two-stage generator, in accordance with one or more embodiments described herein.

FIG. 6 depicts an example of the operation of a second part of the two-stage generator, in accordance with one or more embodiments described herein.

FIG. 7 depicts an additional process that can modify a result dataset to include a dataset extrapolated from a model dataset, in accordance with one or more embodiments described herein.

FIG. 8 depicts an additional process that can modify a result dataset to include a dataset extrapolated from a model dataset, in accordance with one or more embodiments described herein.

FIG. 9 depicts example computer programming code for implementing a generative component, in accordance with one or more embodiments.

FIG. 10 depicts example computer programming code for implementing a discriminator component, in accordance with one or more embodiments.

FIG. 11 depicts example computer programming code for implementing an inverse copula component and an inverse marginal CDF component, in accordance with one or more embodiments.

FIG. 12 depicts example computer programming code for implementing a critic component, in accordance with one or more embodiments.

FIG. 13 illustrates a flow diagram of an example, non-limiting computer-implemented method that can facilitate generating a synthetic dataset from a model dataset, in accordance with one or more embodiments described herein.

FIG. 14 illustrates a block diagram of an example, non-limiting operating environment in which one or more embodiments described herein can be facilitated.

FIG. 15 illustrates a block diagram of example, non-limiting, computer environment in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, with like referenced numerals being used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

It is noted that the claims and scope of the subject application, and any continuation, divisional or continuation-in-part applications claiming priority to the subject application, exclude embodiments (e.g., systems, apparatus, methodologies, computer program products and computer-readable storage media) directed to implanted electrical stimulation for pain treatment and/or management.

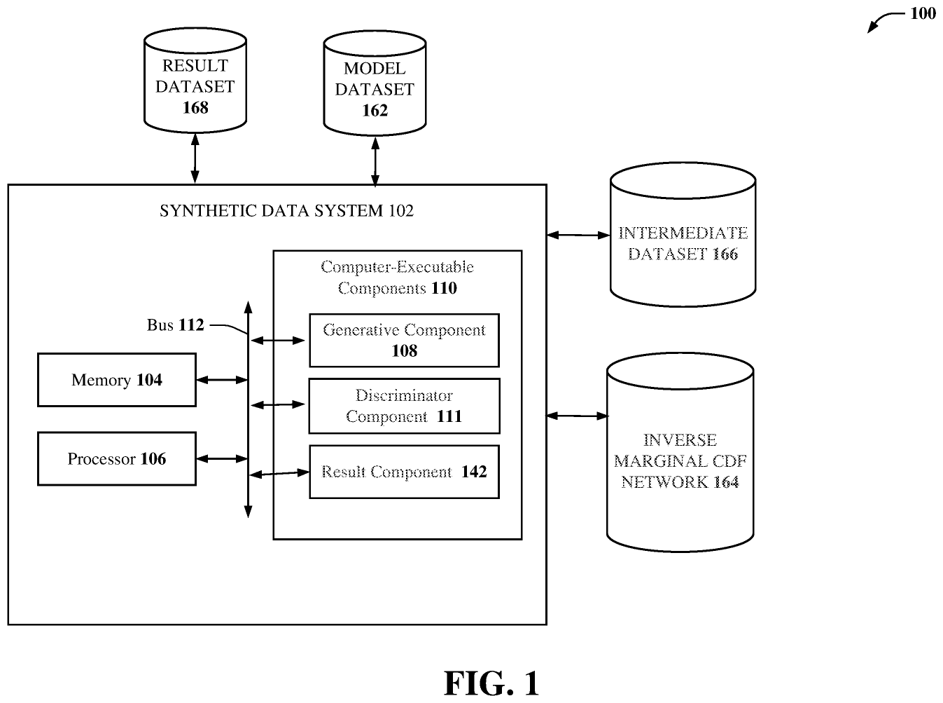

FIG. 1 illustrates a block diagram 100 of an example, non-limiting synthetic data system 102 for utilizing an intermediate dataset to generate a synthetic dataset based on a model dataset, in accordance with one or more embodiments described herein. Embodiments of systems (e.g., synthetic data system 102 and the like), apparatuses or processes in various embodiments of the present disclosure can constitute one or more machine-executable components embodied within one or more machines, e.g., embodied in one or more computer readable mediums (or media) associated with one or more machines. Such components, when executed by the one or more machines, (e.g., computers, computing devices, virtual machines), can cause the machines to perform the operations described. Repetitive description of like elements and processes employed in respective embodiments is omitted for sake of brevity.

As shown in FIG. 1, some embodiments can comprise a synthetic data system 102 that can utilize an intermediate dataset to generate a synthetic dataset based on a model dataset, in accordance with one or more embodiments described herein. Repetitive description of like elements employed in one or more embodiments described herein is omitted for sake of brevity.

In an example embodiment depicted, synthetic data system 102 can be coupled to result dataset 168, model dataset 162, intermediate dataset 166, and inverse marginal CDF network 164. In some embodiments, synthetic data system 102 can comprise memory 104, processor 106, and computer-executable components 110, coupled to bus 112. It should be noted that, when an element is referred to herein as being “coupled” to another element, it can describe one or more different types of coupling. For example, when an element is referred to herein as being “coupled” to another element, it can be described one or more different types of coupling including, but not limited to, chemical coupling, communicative coupling, capacitive coupling, electrical coupling, electromagnetic coupling, inductive coupling, operative coupling, optical coupling, physical coupling, thermal coupling, and another type of coupling.

The synthetic data system 102 can include any suitable computing device or set of computing devices that can be communicatively coupled to devices, non-limiting examples of which can include, but are not limited to, a server computer, a computer, a mobile computer, a mainframe computer, an automated testing system, a network storage device, a communication device, a web server device, a network switching device, a network routing device, a gateway device, a network hub device, a network bridge device, a control system, or any other suitable computing device. A device can be any device that can communicate information with the synthetic data system 102 and/or any other suitable device that can employ information provided by synthetic data system 102 and can enable computer-executable components 110, discussed below. As depicted, computer-executable components 110 can include generative component 108, discriminator component 111, result component 142, and any other components associated with synthetic data system 102 that can combine to provide different functions described herein.

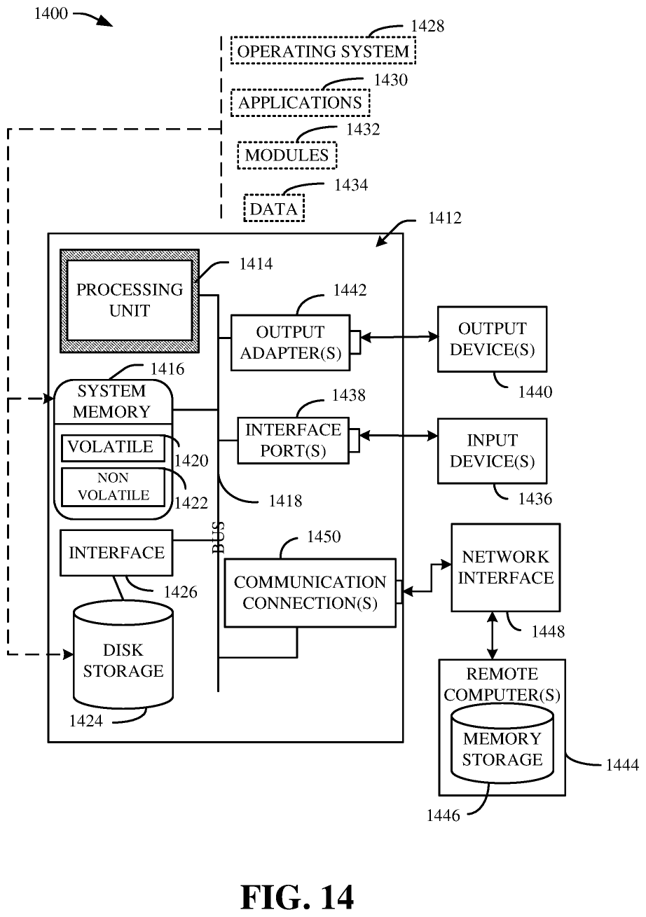

Memory 104 can comprise volatile memory (e.g., random access memory (RAM), static RAM (SRAM), dynamic RAM (DRAM), etc.) and non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 104 are described below with reference to system memory 1404 and FIG. 14. Such examples of memory 104 can be employed to implement any of the embodiments described herein.

In one or more embodiments, memory 104 can store one or more computer and machine readable, writable, and executable components and instructions that, when executed by processor 106 (e.g., a classical processor, and a quantum processor), can perform operations defined by the executable components and instructions. For example, memory 104 can store computer and machine readable, writable, and computer-executable components 110 and instructions that, when executed by processor 106, can execute the various functions described herein relating to synthetic data system 102, including generative component 108, discriminator component 111, result component 142, and other components described herein with or without reference to the various figures of the one or more embodiments described herein.

Processor 106 can comprise one or more types of processors and electronic circuitry (e.g., a classical processor, and a quantum processor) that can implement one or more computer and machine readable, writable, and executable components and instructions that can be stored on memory 104. For example, processor 106 can perform various operations that can be specified by such computer and machine readable, writable, and executable components and instructions including, but not limited to, logic, control, input/output (I/O), arithmetic, and the like. In some embodiments, processor 106 can comprise one or more central processing unit, multi-core processor, microprocessor, dual microprocessors, microcontroller, System on a Chip (SOC), array processor, vector processor, quantum processor, and another type of processor. Further examples of processor 106 are described below with reference to processing unit 1414 and FIG. 14. Such examples of processor 106 can be employed to implement any embodiments described herein.

According to multiple embodiments, result dataset 168, model dataset 162, intermediate dataset 166, and inverse marginal CDF network 164, represent stored data that can facilitate operation of one or more embodiments. As discussed below, this stored data can have been generated by a type of artificial neural network (ANN), and be stored in storage that can include, but is not limited to, RAM, ROM, EEPROM, flash memory or other memory technology, solid state drive (SSD) or other solid-state storage technology, Compact Disk Read Only Memory (CD ROM), digital video disk (DVD), blu-ray disk, or other optical disk storage, magnetic cassettes, magnetic tape, magnetic disk storage or other magnetic storage devices, or any other medium which can be used to store information for embodiments and which can be accessed by the computer.

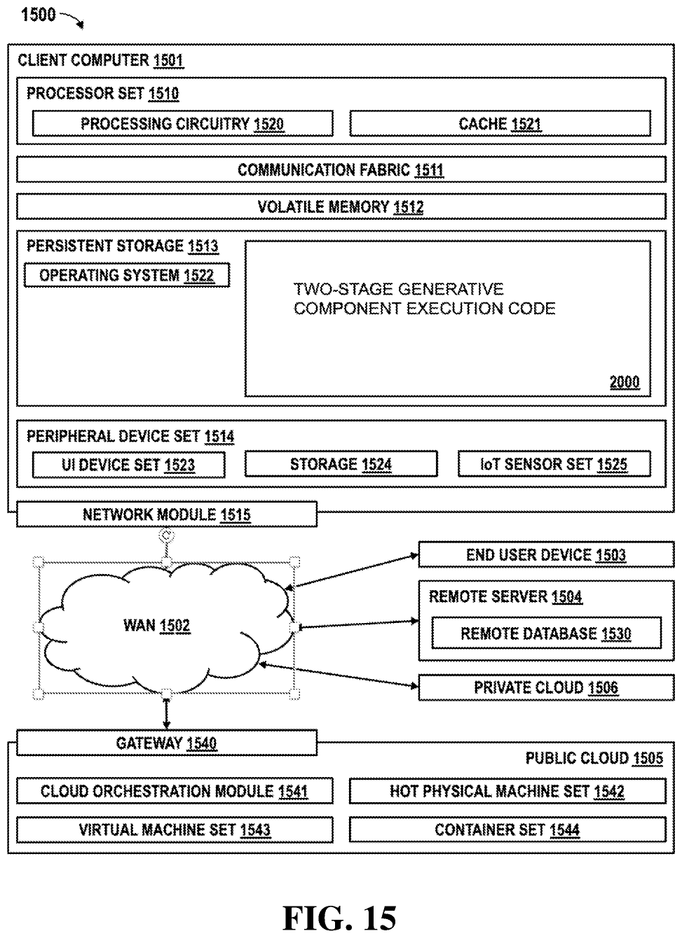

As depicted, memory 104, processor 106, generative component 108, discriminator component 111, result component 142, and any other component of synthetic data system 102 described or suggested herein, can be communicatively, electrically, operatively, and optically coupled to one another via bus 112, to perform functions of synthetic data system 102, and any components coupled thereto. Bus 112 can comprise one or more of a memory bus, memory controller, peripheral bus, external bus, local bus, a quantum bus, and another type of bus that can employ various bus architectures. Further examples of bus 112 are described below with reference to system bus 1518 and FIG. 15. Such examples of bus 112 can be employed to implement any of the embodiments described herein.

In one or more embodiments described herein, synthetic data system 102 can utilize generative component 108 to perform (e.g., via processor 106) operations including, but not limited to, generating an inverse copula network that includes intermediate dataset 166 of objects, the generating being based on unform noise and a discriminator network that was generated based on a model dataset 162. One having skill in the relevant art(s), given the description herein, will appreciate that generative component 108 and discriminator component 111 can be combined in a GAN, with generative component 108 generating inverse copula 230 from independent uniform noise 212B, and discriminator network determining how similar the generated objects are to actual objects of model dataset 162.

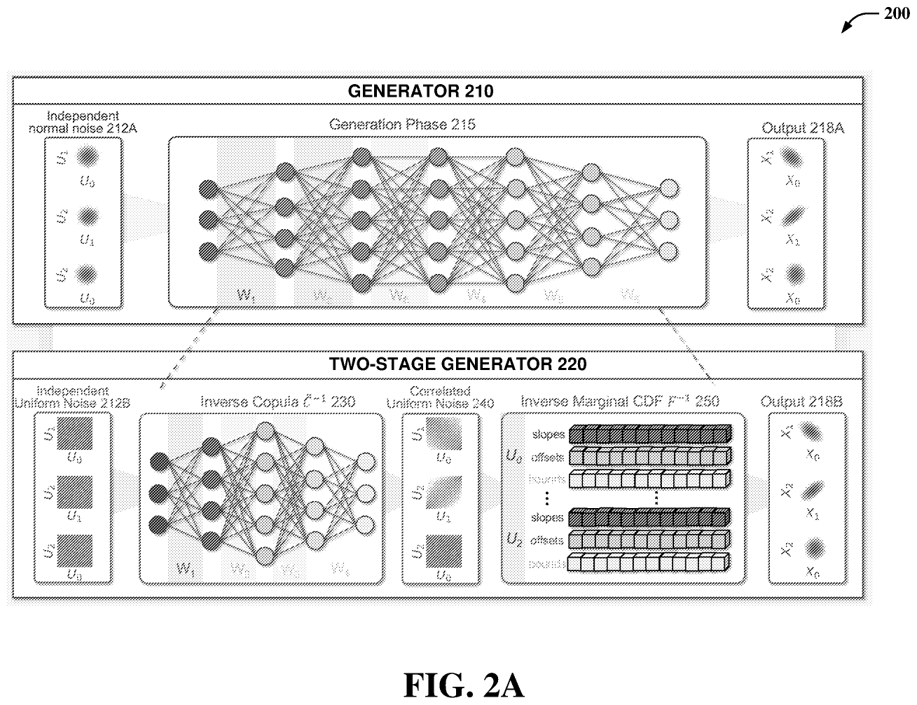

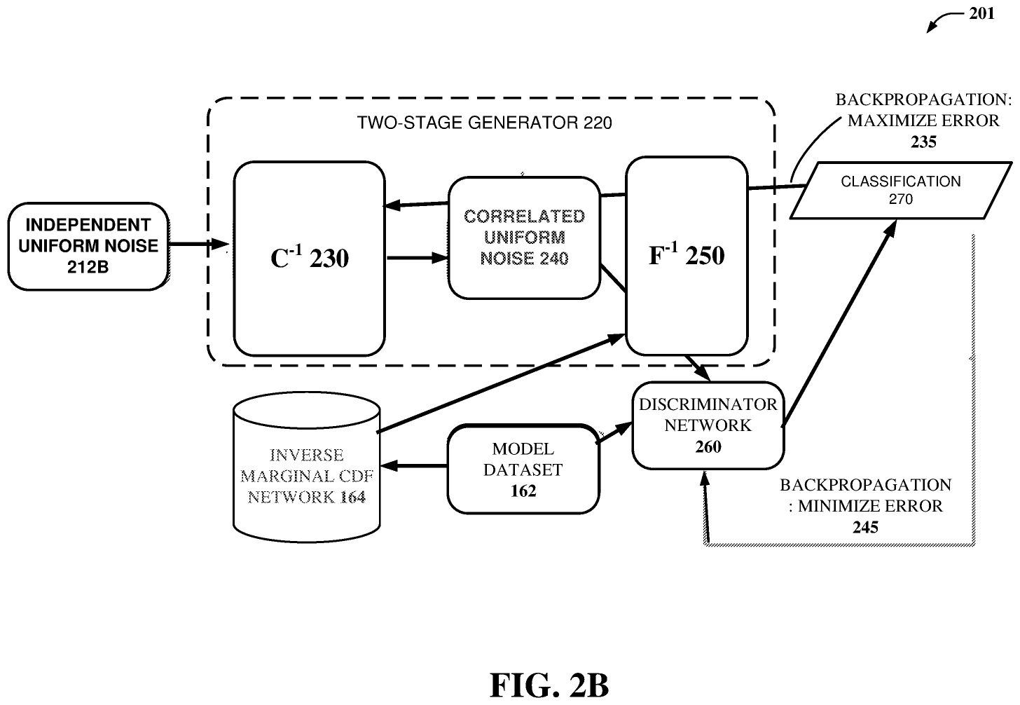

As used herein, intermediate dataset 166 can also be referred to by characteristics of an implementation of intermediate dataset 166, e.g., an ‘inverse copula network’ described with FIG. 2 below. The term ‘intermediate’ can be applied to intermediate dataset 166 based in this dataset being used to exchange data between two stages of synthetic dataset generation described herein. As discussed in further detail below, intermediate dataset 166 can be beneficially evaluated and manipulated during the synthetic dataset generation processes described herein.

In one or more embodiments described herein, synthetic data system 102 can utilize result component 142 to perform (e.g., via processor 106) operations including, but not limited to, utilizing intermediate dataset 166 generated by generative component 108 and discriminator component 111 as input for an inverse marginal CDF network 164, resulting in result dataset 168. In one or more embodiments, the inverse marginal CDF network was generated based on respective marginal cumulative distribution values of the model dataset.

It should be appreciated that the embodiments described herein depict in various figures disclosed herein are for illustration only, and as such, the architecture of such embodiments are not limited to the systems, devices, and components depicted therein. For example, in some embodiments, synthetic data system 102 can further comprise various computer and computing-based elements described herein with reference to section below such as operating environment 1400 of FIG. 14, cloud computing environment 1550 of FIG. 15, and the functional abstraction layers detailed with FIG. 16. In various embodiments, components of the synthetic data system 102 (such as generative component 108, discriminator component 111, and result component 142) can include functional elements that can be implemented via cloud technologies, physical components (for example, computer hardware) and local software (for example, an application on a mobile phone or an electronic device).

FIG. 2A illustrates a block diagram of an example, non-limiting system 200 that can utilize alternate implementations of a DNN to generate a synthetic dataset, in accordance with one or more embodiments described herein. Repetitive description of like elements employed in one or more embodiments described herein is omitted for sake of brevity.

A first example depicted in FIG. 2A includes generator 210, with generation phase 215 (e.g., a deep neural network (DNN)) having an input of 212A and an output of 218A. A second example depicted includes two-stage generator 220 with an input of independent noise 212B (e.g., similar to independent noise 212A), and an output of output 218B (e.g., similar to output 218A). For two-stage generator 220, as an alternative to generation phase 215 DNN, two-stages are utilized, e.g., first stage inverse copula C⁻¹ 230 DNN using independent uniform noise 212B to generate correlated uniform noise 240 as input to inverse marginal CDF F⁻¹ 250, that generates output 218B.

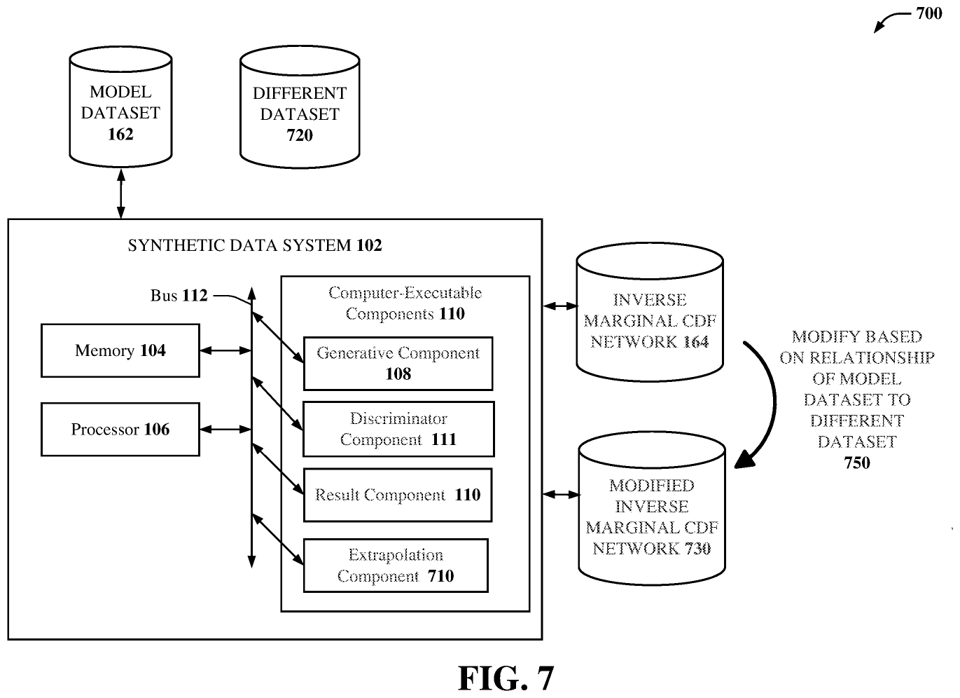

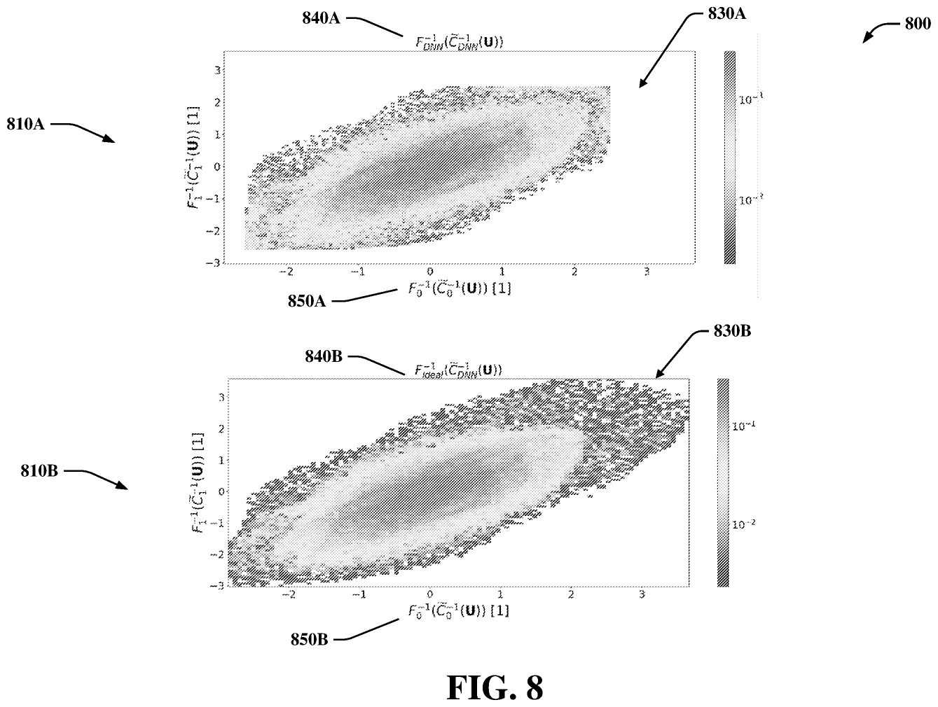

In an implementation, generator 210 can use DNN in generation phase 215 to transform independent normal noise 212A into output 218A. In this implementation, generation phase 210 operates as a ‘black box,’ e.g., without any external access to view or change mid-process, intermediate values used to perform the translation. In a contrasting implementation to generator 210, a generative network similar to generator 210 can be restructured into two separate networks with well-defined functions, e.g., two-stage generator 220 with inverse copula network 250 and an inverse marginal network 250. In some implementations, operating in the two-stages described can provide benefits such as visibility into the operation of two-stage generator 220 (e.g., generative component 108) as well as opportunities to modify the operation of two-stage generator 220, e.g., discussed with FIGS. 7 and 8 below.

In some implementations, the inverse marginal network (e.g., also represented by F⁻¹ 250 herein) can be implemented in a piece-wise, linear fashion because each output can be known to depend only on its corresponding input. In some circumstances, this approach can avoid the need for hyper-parameter scans and training for two separate networks. As described further in FIG. 2B, two-stage generator 220 can be implemented as a part of a GAN that further utilizes backpropagation from discriminator network 260 to provide output 218B (e.g., result dataset 168).

FIG. 2B illustrates a block diagram of an example, non-limiting system 201 that can utilize two stage generator 220 operating in a GAN with discriminator network 260, in accordance with one or more embodiments. As depicted, model dataset 162 can be used to generate inverse marginal CDF network 164 and provide a model for discriminator network 260 to classify output from two stage generator as “real or fake” (e.g., classification 270). Backpropagation based on classification 270 is discussed further below.

In some implementations, a GAN such as system 201 may include two networks training simultaneously. The discriminator network 260 learns to distinguish whether a given data instance is “real or not,” (e.g., similar to model dataset 162) and a generative component 108 learns to confuse discriminator network 260 by generating high quality data, similar to model dataset 162. The discriminative and generative networks can be implemented by deep learning neural networks (DNNs).

In an implementation, two-stage generator 220 can be implemented by generative component 108 to operate in a GAN with discriminator component 111 implementing discriminator network. With respect to this example GAN, in one or more embodiments, based on classification 270 (e.g., “real or fake” by discriminator network 260) either the weights of C⁻¹ 230 are modified by backpropagation to maximize errors 235 by discriminator network 260 or the weights of discriminator network 260 are modified by backpropagation to minimize errors 245 by discriminator network 260.

In an implementation, the type of GAN implemented by system 201 corresponds to a Wasserstein generative adversarial network which can measure the distance between the distributions of real and generated samples. Further, Wasserstein GANs can also use gradient penalties to ensure that the discriminator function maintains stability and avoids mode collapse. In some implementations, a gradient penalty term encourages a discriminator function to have gradients with a fixed magnitude, which can prevent the discriminator from collapsing and assigning high confidence to all generated samples, leading to mode collapse.

With respect to the backpropagation 235 to C⁻¹ 230, it should be noted that, just as the results of two-stage generator 250 were provided from C⁻¹ 230 to discriminator 260 via F⁻¹ 250, the backpropagation to C⁻¹ 230 is provided back via F⁻¹ 250. In one or more embodiments, this use of inverse marginal CDF network 164 to process by F⁻¹ 250, output from and input into two-stage generator 220, can facilitate the benefits noted herein that can be provided by two-stage generator 220 in contrast to generator 210.

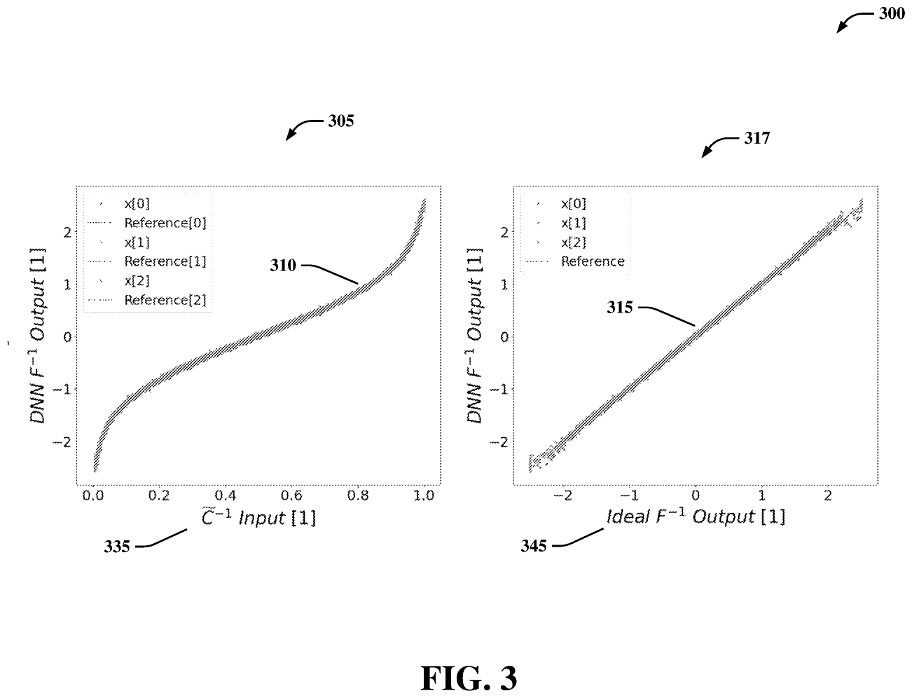

Continuing this example, based on the operation of the GAN of system 201, result dataset 168 results as a synthetic dataset that is similar to model dataset 162. FIGS. 3-6 and the respective descriptions below provide additional details regarding the operation of two-stage generator 220, and FIGS. 7-8 describe how in some implementations, by operating in two-stages, two-stage generator 220 can enable the generation of a result dataset 168 that is extrapolated to include results beyond the examples included in model dataset 162.

FIG. 3 depicts example charts of values 300 associated with a system that utilizes an intermediate dataset to generate a synthetic dataset, in accordance with one or more embodiments described herein. Repetitive description of like elements employed in one or more embodiments described herein is omitted for sake of brevity.

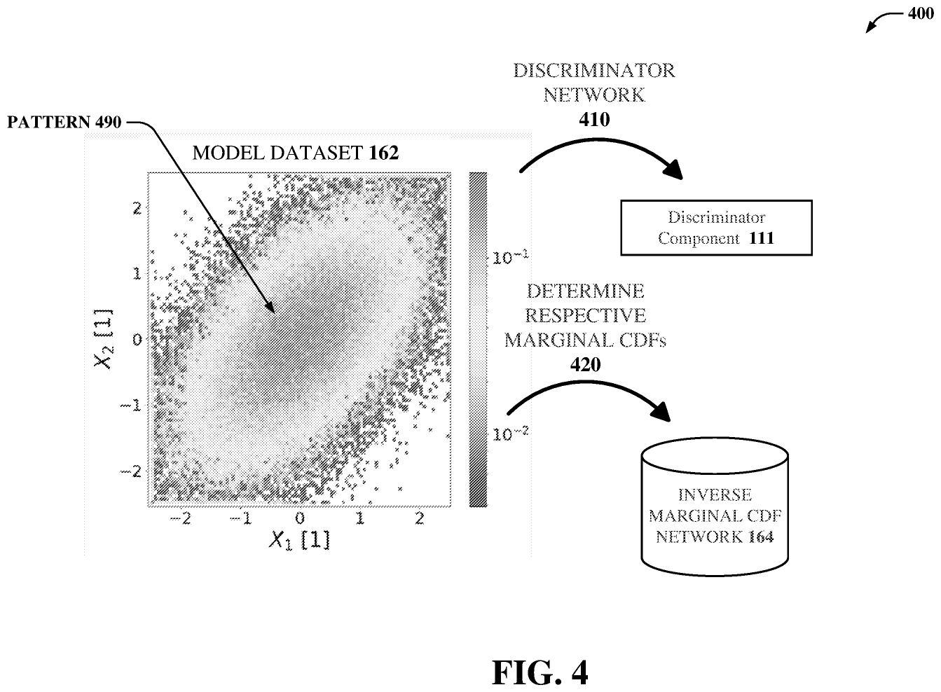

In some implementations, chart 305 describes values associated with the generation of C⁻¹ 230 and the application of F⁻¹ 250 discussed above. As further depicted, chart 317 describes example values of C⁻¹ 230 and F⁻¹ 250 that can result in some of the synthetic results described herein. For example, chart line 310 of chart 305 depicts a uniform distribution of data elements, and chart 317 depicts values of inverse marginal CDF network 164 generated based on model dataset 162. By using the data of chart 305 as input to inverse marginal CDF network 164 (e.g., applying the inverse of the marginal CDF to the captured correlations), result dataset 168 may correspond to a synthetic dataset that is similar to the model dataset. Detailed examples of the processes described with FIG. 3 are included with FIGS. 4-6 below.

FIG. 4 depicts a process 400 where model dataset 162 may be used to generate multiple derived sets of data for performance of different embodiments described herein, in accordance with one or more embodiments. Repetitive description of like elements employed in one or more embodiments described herein is omitted for sake of brevity.

Process 400 begins with an example model dataset 162. In embodiments, this model dataset 162 can provide an example for the generation of synthetic datasets similar to model dataset 162, e.g., by a process similar to the GAN described with FIG. 2B above. As depicted, model dataset 162 includes a distribution of data that, when charted, results in pattern 490. As described further below, one or more embodiments may generate synthetic data that has a similar pattern when charted.

As noted above, discriminator network 260 as an adversarial element that operates based on model dataset 162, e.g., with model dataset 162 providing examples for classification 270. At 410, one approach to this training is depicted that utilizes discriminator component 111 to iteratively train discriminator network 260 based on the output of generative component 108 compared to aspects of model dataset 162, e.g., by discriminator component 111.

At this initial stage, as depicted at 420, respective marginal CDFs used by F⁻¹ 250 can be generated based on model dataset 162. In an implementation, inverse marginal CDF network 164 can be generated to reflect a uniform distribution of captured respective marginal distributions of model dataset 162.

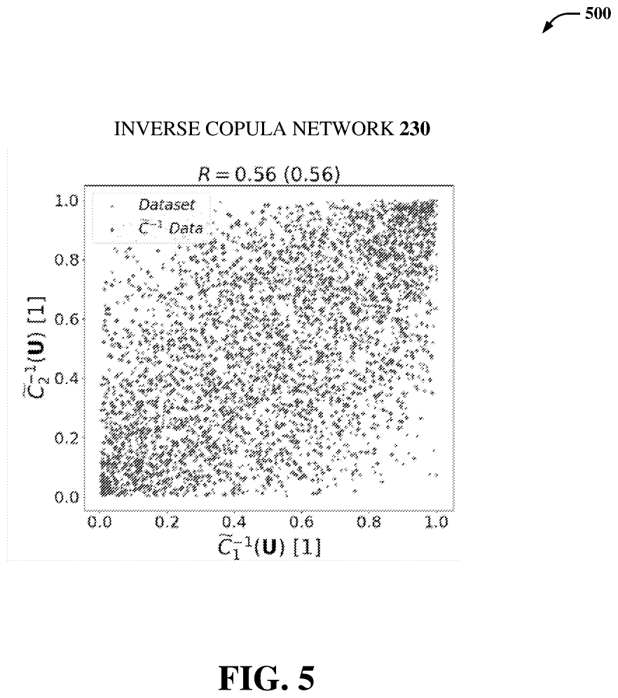

FIG. 5 depicts an example 500 of an inverse copula network that can result from operation of the first stage of two-stage generator 220 (e.g., C⁻¹ 230), in accordance with one or more embodiments described herein. Repetitive description of like elements employed in one or more embodiments described herein is omitted for sake of brevity.

In this example, the depicted inverse copula network 230 can result from the iterative operation of generative component 108 and adversarial discriminator component 111, e.g., in a GAN described with FIG. 2B above.

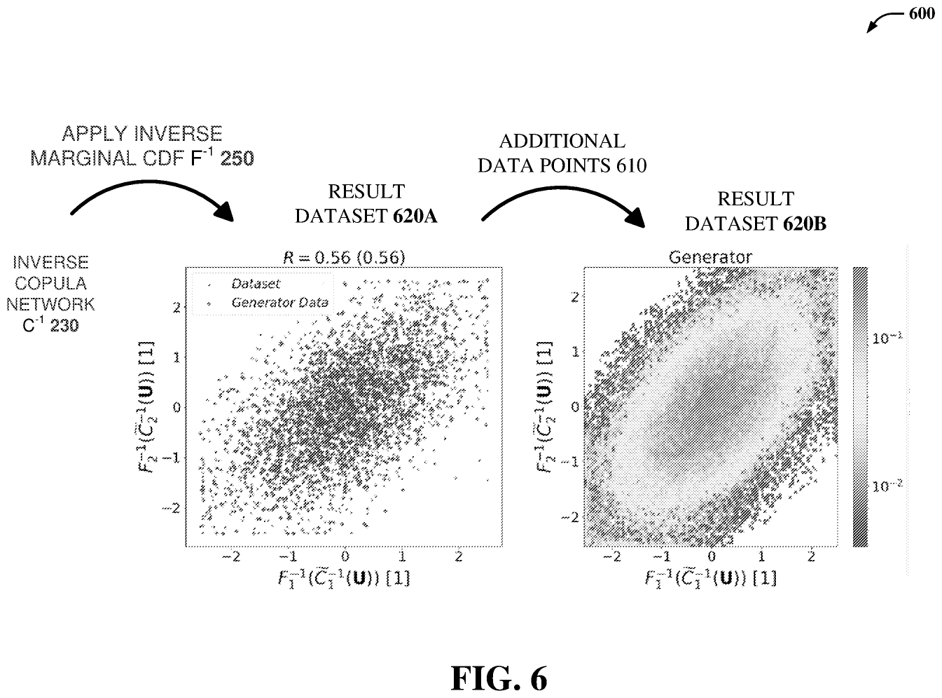

FIG. 6 depicts an example 600 of the operation of a part of two-stage generator 220, in accordance with one or more embodiments described herein. Repetitive description of like elements employed in one or more embodiments described herein is omitted for sake of brevity.

In this example, inverse marginal CDF is applied to inverse copula network 230 resulting in result dataset 620A, e.g., output 218B of two-stage generator 220. Omitted from the depiction of FIG. 6 is the iterative operation of the GAN described with FIG. 2B above. At 610, further generative and adversarial activity may be performed to yield additional data points 610, and these additional data points may yield result dataset 620B, e.g., similar to model dataset 162.

FIGS. 7 and 8 depict an additional process that may modify result dataset 168 to include a dataset extrapolated from model dataset 162, in accordance with one or more embodiments described herein. Repetitive description of like elements employed in one or more embodiments described herein is omitted for sake of brevity.

As described herein, inverse copula network 230 can capture the correlations (also termed herein the dependence structure) of the generated data in a normalized fashion, and inverse marginal CDF network 164 can captures the respective marginal distributions present within model dataset 162. Because of this example two-stage approach, instead of acting as a ‘black box,’ (e.g., similar to the implementation of generator 210) embodiments may increase the transparency and interpretability of DNNs using the two-stage approaches described herein. For example, each constituent network of the two-stage approach described herein performs a particular defined function that can manipulate intermediate data visible during the performance of the two stages, e.g., inverse copula network 230 and correlated uniform noise 240.

In the example depicted in FIG. 7, computer-executable components 110 further includes extrapolation component 710. In an implementation when different dataset 720 is estimated be predictably different from model dataset 162, in some circumstances, inverse marginal CDF network 164 (e.g., derived from model dataset 162) may be transformed in accordance with the predictable differences between model dataset 162 and different dataset 720. For example, when model dataset 162 includes data describing people of a particular area, a different area may be selected that has a predictable differences, e.g., there are more people in the different area with a particular height than there are in the area reflected by model dataset 162.

At 750, instead of utilizing inverse marginal CDF network 164, an embodiment can use modified inverse marginal CDF network 730. In one or more embodiment, by modifying the respective marginal distributions present within the data (e.g., of the height attribute), result dataset may reflect the height distribution of different dataset 720. It should be noted that this approach to useful manipulation of modified inverse marginal CDF network 730 is non-limiting, and other types of modification and application of inverse marginal CDF network 164 can be utilized. An example use of this approach to extrapolate data to augment result dataset 168 is provided with the discussion of FIG. 8 below.

FIG. 8 depicts an example 800 of the use of one or more embodiments to generate synthetic data to fill in missing areas of a dataset by extrapolation, in accordance with one or more embodiments. Repetitive description of like elements employed in one or more embodiments described herein is omitted for sake of brevity.

In the example depicted in chart 810A, the missing areas of a dataset include talk regions with less or no available data to analyze. One or more embodiments may be used to synthetically generate a dataset that models missing tail regions from model dataset 162. This tail region extrapolation may be useful to modeling fundamental science, finance, reliability engineering, and the creative arts, e.g., areas where datasets may be limited.

As depicted in FIG. 8, chart 810A shows an example dataset where area 830A does not include useful measured or generated data. To extrapolate missing data for a particular range, the inverse marginal CDF network formula 840A (e.g., with the subscript ‘DNN’) that would be used by previous examples (e.g., FIGS. 2A-2B), may be replaced (e.g., by extrapolation component 710) by modified inverse marginal CDF network formula 840B, e.g., with subscript ‘IDEAL.’ That is, F_{DNN}⁻¹ of 810A can be replaced with F_{ideal}⁻¹ of 810B because the marginals extrapolated are for a specific region and the values are normally distributed in inverse copula network 230. In this example, tail region 830B of the modified CDF network can be populated with the extrapolated data from the modification.

In one or more embodiments, synthetic data system 102 can employ hardware and/or software to solve problems that are highly technical in nature, including improving the performance of the generation of synthetic datasets. One having skill in the relevant art(s), given the disclosure herein, would appreciate that the technical problems that can be solved by one or more embodiments described herein are not abstract and cannot be performed as a set of mental acts by a human. For example, the iterative processes described above performed by components including, discriminator component 111, generative component 108, result component 142, and other components of methods and systems described herein, at least because of the complex and rapid iterations performed by generative component 108, are not abstract and cannot be performed as a set of mental acts by a human.

Further, in certain embodiments, some of the processes performed can be performed by one or more specialized computers (e.g., one or more specialized processing units, a specialized computer such as tomography and reconstruction, statistical estimation, and so on) for carrying out defined tasks related to generating synthetic datasets from model datasets. As described herein, synthetic data system 102 improve processes associated with the use of deep neural networks and synthetic data generation. One or more embodiments, in addition to improving approaches to solving existing problems associated with machine learning applications, also can be employed to solve new problems that arise through advancements in technologies mentioned above, computer architecture, and/or the like.

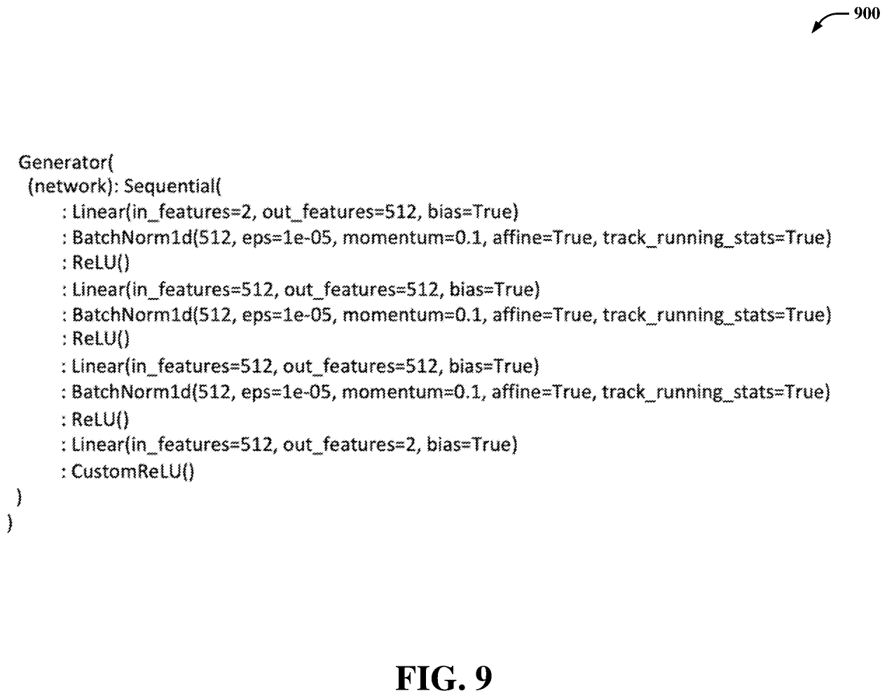

FIGS. 9-12 include example programming code in PyTorch that provides non-limiting examples of approaches to implementing one or more embodiments described herein.

FIG. 9 depicts example computer programming code for implementing a generative component, in accordance with one or more embodiments. In an example, this code could be used to implement generative component 108. Repetitive description of like elements employed in one or more embodiments described herein is omitted for sake of brevity.

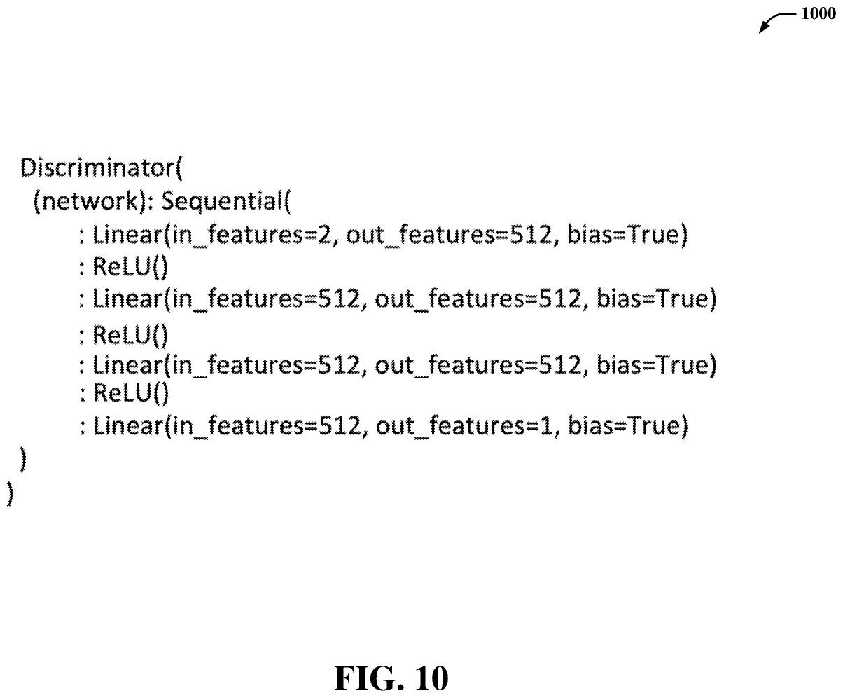

FIG. 10 depicts example computer programming code for implementing a discriminator component, in accordance with one or more embodiments. In an example, this code could be used to implement discriminator component 111. Repetitive description of like elements employed in one or more embodiments described herein is omitted for sake of brevity.

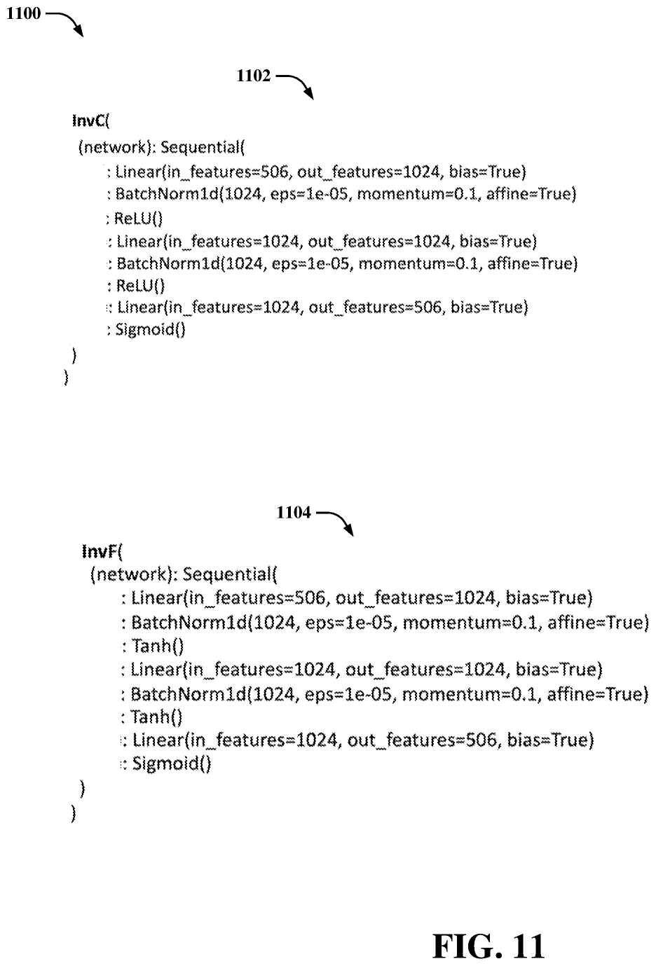

FIG. 11 depicts example computer programming code for implementing an inverse copula component, and an inverse marginal CDF component, in accordance with one or more embodiments. In an example, this code could be used to implement the components used for C⁻¹ 230 and F⁻¹ 250, respectively. Repetitive description of like elements employed in one or more embodiments described herein is omitted for sake of brevity.

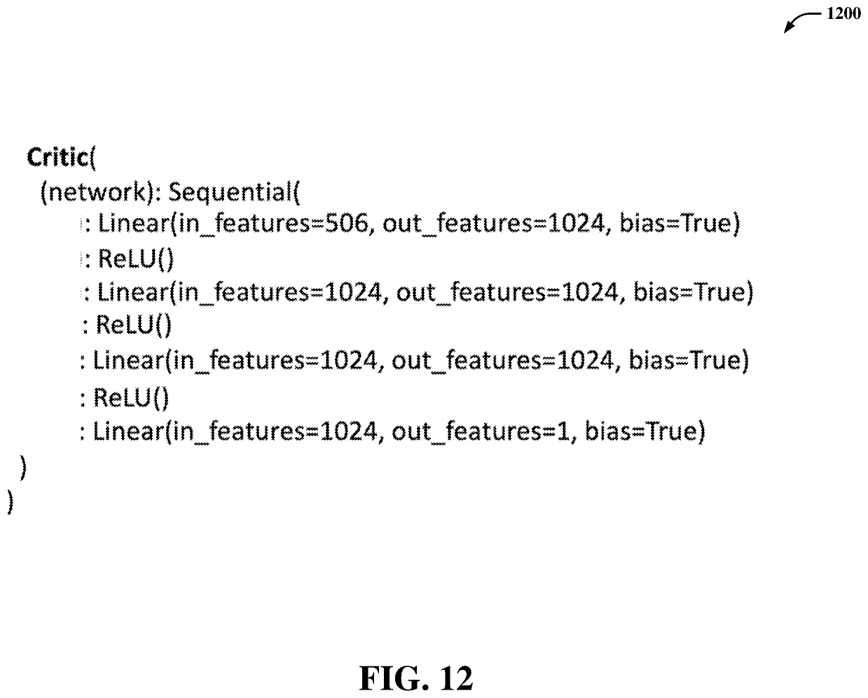

FIG. 12 depicts example computer programming code for implementing a critic component, in accordance with one or more embodiments. In an example, this code could be used to implement an alternative to discriminator component 111. Repetitive description of like elements employed in one or more embodiments described herein is omitted for sake of brevity.

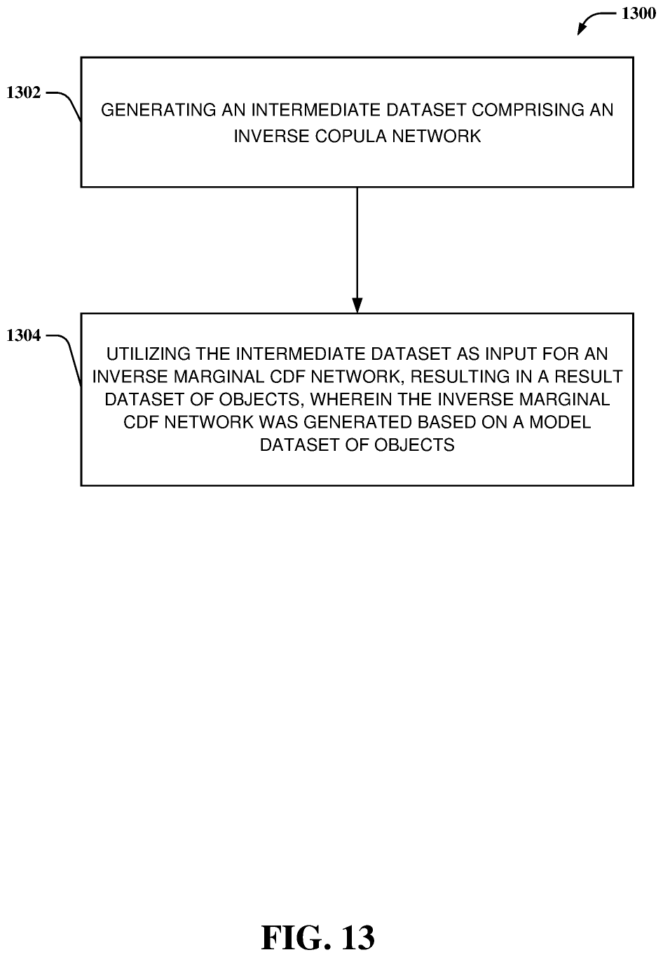

FIG. 13 illustrates a flow diagram of an example, non-limiting computer-implemented method 1300 that can facilitate generating a synthetic dataset from a model dataset, in accordance with one or more embodiments described herein. Repetitive description of like elements and processes employed in respective embodiments is omitted for sake of brevity.

At 1302, computer-implemented method 1300 can include generating an intermediate dataset comprising an inverse copula network. For example, in one or more embodiments, computer-implemented method 1300 can include generating inverse copula network 230, with inverse copula network 230 being generated by generative component 108 based on unform noise 212B.

At 1304, computer-implemented method 1300 can include utilizing, by the device, the intermediate dataset as input for an inverse marginal CDF network, resulting in a result dataset of objects, with the inverse marginal CDF network being generated based on a model dataset of objects. For example, in one or more embodiments, computer-implemented method 1300 can include utilizing inverse copula network 230 (e.g., generated by generative component 108) as input for application of inverse marginal CDF network 250, resulting in a result dataset 168, with inverse marginal CDF network 164 being generated based on model dataset 162.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

In order to provide a context for the various aspects of the disclosed subject matter, FIG. 14 as well as the following discussion are intended to provide a general description of a suitable environment in which the various aspects of the disclosed subject matter can be implemented. FIG. 14 illustrates a block diagram of an example, non-limiting operating environment in which one or more embodiments described herein can be facilitated. Repetitive description of like elements employed in other embodiments described herein is omitted for sake of brevity.

FIG. 14 and the following discussion are intended to provide a brief, general description of a suitable operating environment 1400 in which one or more embodiments described herein at FIGS. 1-13 can be implemented. For example, one or more components and/or other aspects of embodiments described herein can be implemented in or be associated with, such as accessible via, the operating environment 1400. Further, while one or more embodiments have been described above in the general context of computer-executable instructions that can run on one or more computers, those skilled in the art will recognize that one or more embodiments also can be implemented in combination with other program modules and/or as a combination of hardware and software.

Generally, program modules include routines, programs, components, data structures and/or the like, that perform particular tasks and/or implement particular abstract data types. Moreover, the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and/or the like, which can be operatively coupled to one or more associated devices.

Computing devices typically include a variety of media, which can include computer-readable storage media, machine-readable storage media and/or communications media, which two terms are used herein differently from one another as follows. Computer-readable storage media or machine-readable storage media can be any available storage media that can be accessed by the computer and includes both volatile and nonvolatile media, removable and non-removable media. By way of example, but not limitation, computer-readable storage media and/or machine-readable storage media can be implemented in connection with any method or technology for storage of information such as computer-readable and/or machine-readable instructions, program modules, structured data and/or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) and/or other optical disk storage, magnetic cassettes, magnetic tape, magnetic disk storage and/or other magnetic storage devices, solid state drives or other solid state storage devices and/or other tangible and/or non-transitory media which can be used to store specified information. In this regard, the terms “tangible” or “non-transitory” herein as applied to storage, memory and/or computer-readable media, are to be understood to exclude only propagating transitory signals per se as modifiers and do not relinquish rights to all standard storage, memory and/or computer-readable media that are not only propagating transitory signals per se.

Computer-readable storage media can be accessed by one or more local or remote computing devices, e.g., via access requests, queries and/or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set and/or changed in such a manner as to encode information in one or more signals. By way of example, but not limitation, communication media can include wired media, such as a wired network, direct-wired connection and/or wireless media such as acoustic, RF, infrared and/or other wireless media.

With reference again to FIG. 14, the example operating environment 1400 for implementing one or more embodiments of the aspects described herein can include a computer 1402, the computer 1402 including a processing unit 1406, a system memory 1404 and/or a system bus 1408. One or more aspects of the processing unit 1406 can be applied to processors such as 106 of the non-limiting synthetic data system 102. The processing unit 1406 can be implemented in combination with and/or alternatively to processors such as 106.

Memory 1404 can store one or more computer and/or machine readable, writable and/or executable components and/or instructions that, when executed by processing unit 1406 (e.g., a classical processor, a quantum processor and/or like processor), can facilitate performance of operations defined by the executable component(s) and/or instruction(s). For example, memory 1404 can store computer and/or machine readable, writable and/or executable components and/or instructions that, when executed by processing unit 1406, can facilitate execution of the one or more functions described herein relating to non-limiting synthetic data system 102, as described herein with or without reference to the one or more figures of the one or more embodiments.

Memory 1404 can comprise volatile memory (e.g., random access memory (RAM), static RAM (SRAM), dynamic RAM (DRAM) and/or the like) and/or non-volatile memory (e.g., read only memory (ROM), programmable ROM (PROM), electrically programmable ROM (EPROM), electrically erasable programmable ROM (EEPROM) and/or the like) that can employ one or more memory architectures.

Processing unit 1406 can comprise one or more types of processors and/or electronic circuitry (e.g., a classical processor, a quantum processor and/or like processor) that can implement one or more computer and/or machine readable, writable and/or executable components and/or instructions that can be stored at memory 1404. For example, processing unit 1406 can perform one or more operations that can be specified by computer and/or machine readable, writable and/or executable components and/or instructions including, but not limited to, logic, control, input/output (I/O), arithmetic and/or the like. In one or more embodiments, processing unit 1406 can be any of one or more commercially available processors. In one or more embodiments, processing unit 1406 can comprise one or more central processing unit, multi-core processor, microprocessor, dual microprocessors, microcontroller, System on a Chip (SOC), array processor, vector processor, quantum processor and/or another type of processor. The examples of processing unit 1406 can be employed to implement one or more embodiments described herein.

The system bus 1408 can couple system components including, but not limited to, the system memory 1404 to the processing unit 1406. The system bus 1408 can comprise one or more types of bus structure that can further interconnect to a memory bus (with or without a memory controller), a peripheral bus and/or a local bus using one or more of a variety of commercially available bus architectures. The system memory 1404 can include ROM 1410 and/or RAM 1412. A basic input/output system (BIOS) can be stored in a non-volatile memory such as ROM, erasable programmable read only memory (EPROM) and/or EEPROM, which BIOS contains the basic routines that help to transfer information among elements within the computer 1402, such as during startup. The RAM 1412 can include a high-speed RAM, such as static RAM for caching data.

The computer 1402 can include an internal hard disk drive (HDD) 1414 (e.g., EIDE, SATA), one or more external storage devices 1416 (e.g., a magnetic floppy disk drive (FDD), a memory stick or flash drive reader, a memory card reader and/or the like) and/or a drive 1420, e.g., such as a solid state drive or an optical disk drive, which can read or write from a disk 1422, such as a CD-ROM disc, a DVD, a BD and/or the like. Additionally, and/or alternatively, where a solid state drive is involved, disk 1422 could not be included, unless separate. While the internal HDD 1414 is illustrated as located within the computer 1402, the internal HDD 1414 can also be configured for external use in a suitable chassis (not shown). Additionally, while not shown in operating environment 1400, a solid state drive (SSD) can be used in addition to, or in place of, an HDD 1414. The HDD 1414, external storage device(s) 1416 and drive 1420 can be coupled to the system bus 1408 by an HDD interface 1424, an external storage interface 1426 and a drive interface 1428, respectively. The HDD interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, other types of storage media which are readable by a computer, whether presently existing or developed in the future, can also be used in the example operating environment, and/or that any such storage media can contain computer-executable instructions for performing the methods described herein.

A number of program modules can be stored in the drives and RAM 1412, including an operating system 1430, one or more applications 1432, other program modules 1434 and/or program data 1436. All or portions of the operating system, applications, modules and/or data can also be cached in the RAM 1412. The systems and/or methods described herein can be implemented utilizing one or more commercially available operating systems and/or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In a related embodiment, operating system 1430 can comprise one virtual machine (VM) of multiple VMs hosted at computer 1402. Furthermore, operating system 1430 can provide runtime environments, such as the JAVA runtime environment or the .NET framework, for applications 1432. Runtime environments are consistent execution environments that can allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and/or settings for an application.

Further, computer 1402 can be enabled with a security module, such as a trusted processing module (TPM). For instance, with a TPM, boot components hash next in time boot components and wait for a match of results to secured values before loading a next boot component. This process can take place at any layer in the code execution stack of computer 1402, e.g., applied at application execution level and/or at operating system (OS) kernel level, thereby enabling security at any level of code execution.

An entity can enter and/or transmit commands and/or information into the computer 1402 through one or more wired/wireless input devices, e.g., a keyboard 1438, a touch screen 1440 and/or a pointing device, such as a mouse 1442. Other input devices (not shown) can include a microphone, an infrared (IR) remote control, a radio frequency (RF) remote control and/or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint and/or iris scanner, and/or the like. These and other input devices can be coupled to the processing unit 1406 through an input device interface 1444 that can be coupled to the system bus 1408, but can be coupled by other interfaces, such as a parallel port, an IEEE 1394 serial port, a game port, a USB port, an IR interface, a BLUETOOTH® interface and/or the like.

A monitor 1446 or other type of display device can be alternatively and/or additionally coupled to the system bus 1408 via an interface, such as a video adapter 1448. In addition to the monitor 1446, a computer typically includes other peripheral output devices (not shown), such as speakers, printers and/or the like.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device and/or other common network node, and typically includes many or all of the elements described relative to the computer 1402, although, for purposes of brevity, only a memory/storage device 1452 is illustrated. Additionally, and/or alternatively, the computer 1402 can be coupled (e.g., communicatively, electrically, operatively, optically and/or the like) to one or more external systems, sources and/or devices (e.g., classical and/or quantum computing devices, communication devices and/or like device) via a data cable (e.g., High-Definition Multimedia Interface (HDMI), recommended standard (RS) 232, Ethernet cable and/or the like).

In one or more embodiments, a network can comprise one or more wired and/or wireless networks, including, but not limited to, a cellular network, a wide area network (WAN) (e.g., the Internet), or a local area network (LAN). For example, one or more embodiments described herein can communicate with one or more external systems, sources and/or devices, for instance, computing devices (and vice versa) using virtually any specified wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol and/or other proprietary and/or non-proprietary communication protocols. In a related example, one or more embodiments described herein can include hardware (e.g., a central processing unit (CPU), a transceiver, a decoder, quantum hardware, a quantum processor and/or the like), software (e.g., a set of threads, a set of processes, software in execution, quantum pulse schedule, quantum circuit, quantum gates and/or the like) and/or a combination of hardware and/or software that facilitates communicating information among one or more embodiments described herein and external systems, sources and/or devices (e.g., computing devices, communication devices and/or the like).

The logical connections depicted include wired/wireless connectivity to a local area network (LAN) 1454 and/or larger networks, e.g., a wide area network (WAN) 1456. LAN and WAN networking environments can be commonplace in offices and companies and can facilitate enterprise-wide computer networks, such as intranets, all of which can connect to a global communications network, e.g., the Internet.

When used in a LAN networking environment, the computer 1402 can be coupled to the local network 1454 through a wired and/or wireless communication network interface or adapter 1458. The adapter 1458 can facilitate wired and/or wireless communication to the LAN 1454, which can also include a wireless access point (AP) disposed thereon for communicating with the adapter 1458 in a wireless mode.

When used in a WAN networking environment, the computer 1402 can include a modem 1460 and/or can be coupled to a communications server on the WAN 1456 via other means for establishing communications over the WAN 1456, such as by way of the Internet. The modem 1460, which can be internal and/or external and a wired and/or wireless device, can be coupled to the system bus 1408 via the input device interface 1444. In a networked environment, program modules depicted relative to the computer 1402 or portions thereof can be stored in the remote memory/storage device 1452. The network connections shown are merely exemplary and one or more other means of establishing a communications link among the computers can be used.

When used in either a LAN or WAN networking environment, the computer 1402 can access cloud storage systems or other network-based storage systems in addition to, and/or in place of, external storage devices 1416 as described above, such as but not limited to, a network virtual machine providing one or more aspects of storage and/or processing of information. Generally, a connection between the computer 1402 and a cloud storage system can be established over a LAN 1454 or WAN 1456 e.g., by the adapter 1458 or modem 1460, respectively. Upon coupling the computer 1402 to an associated cloud storage system, the external storage interface 1426 can, such as with the aid of the adapter 1458 and/or modem 1460, manage storage provided by the cloud storage system as it would other types of external storage. For instance, the external storage interface 1426 can be configured to provide access to cloud storage sources as if those sources were physically coupled to the computer 1402.

The computer 1402 can be operable to communicate with any wireless devices and/or entities operatively disposed in wireless communication, e.g., a printer, scanner, desktop and/or portable computer, portable data assistant, communications satellite, telephone and/or any piece of equipment or location associated with a wirelessly detectable tag (e.g., a kiosk, news stand, store shelf and/or the like). This can include Wireless Fidelity (Wi-Fi) and BLUETOOTH® wireless technologies. Thus, the communication can be a predefined structure as with a conventional network or simply an ad hoc communication between at least two devices.

The illustrated embodiments described herein can be employed relative to distributed computing environments (e.g., cloud computing environments), such as described below with respect to FIG. 15, where certain tasks are performed by remote processing devices that are linked through a communications network. In a distributed computing environment, program modules can be located both in local and/or remote memory storage devices.

Moreover, the non-limiting synthetic data system 102 and/or the example operating environment 1400 can be associated with and/or be included in a data analytics system, a data processing system, a graph analytics system, a graph processing system, a big data system, a social network system, a speech recognition system, an image recognition system, a graphical modeling system, a bioinformatics system, a data compression system, an artificial intelligence system, an authentication system, a syntactic pattern recognition system, a medical system, a health monitoring system, a network system, a computer network system, a communication system, a router system, a server system, a high availability server system (e.g., a Telecom server system), a Web server system, a file server system, a data server system, a disk array system, a powered insertion board system, a cloud-based system and/or the like. In accordance therewith, non-limiting synthetic data system 102 and/or example operating environment 1400 can be employed to use hardware and/or software to solve problems that are highly technical in nature, that are not abstract and/or that cannot be performed as a set of mental acts by a human.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1500 contains an example of an environment for the execution of at least some of the computer code involved in performing the inventive methods, such as implementation of a two-stage generative component (e.g., generative component 108) by two-stage generative component execution code 2000. In addition to block 2000, computing environment 1500 includes, for example, computer 1501, wide area network (WAN) 1502, end user device (EUD) 1503, remote server 1504, public cloud 1505, and private cloud 1506. In this embodiment, computer 1501 includes processor set 1510 (including processing circuitry 1520 and cache 1521), communication fabric 1511, volatile memory 1512, persistent storage 1513 (including operating system 1522 and block 2000, as identified above), peripheral device set 1514 (including user interface (UI), device set 1523, storage 1524, and Internet of Things (IoT) sensor set 1525), and network module 1515. Remote server 1504 includes remote database 1530. Public cloud 1505 includes gateway 1540, cloud orchestration module 1541, host physical machine set 1542, virtual machine set 1543, and container set 1544.

COMPUTER 1501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1530. As is well understood in the art of computer technology, and depending upon the technology, performance of a computer-implemented method may be distributed among multiple computers and/or between multiple locations. On the other hand, in this presentation of computing environment 1500, detailed discussion is focused on a single computer, specifically computer 1501, to keep the presentation as simple as possible. Computer 1501 may be located in a cloud, even though it is not shown in a cloud in FIG. 15. On the other hand, computer 1501 is not required to be in a cloud except to any extent as may be affirmatively indicated.

PROCESSOR SET 1510 includes one, or more, computer processors of any type now known or to be developed in the future. Processing circuitry 1520 may be distributed over multiple packages, for example, multiple, coordinated integrated circuit chips. Processing circuitry 1520 may implement multiple processor threads and/or multiple processor cores. Cache 1521 is memory that is located in the processor chip package(s) and is typically used for data or code that should be available for rapid access by the threads or cores running on processor set 1510. Cache memories are typically organized into multiple levels depending upon relative proximity to the processing circuitry. Alternatively, some, or all, of the cache for the processor set may be located “off chip.” In some computing environments, processor set 1510 may be designed for working with qubits and performing quantum computing.

Computer readable program instructions are typically loaded onto computer 1501 to cause a series of operational steps to be performed by processor set 1510 of computer 1501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1521 and the other storage media discussed below. The program instructions, and associated data, are accessed by processor set 1510 to control and direct performance of the inventive methods. In computing environment 1500, at least some of the instructions for performing the inventive methods may be stored in block 2000 in persistent storage 1513.

COMMUNICATION FABRIC 1511 is the signal conduction paths that allow the various components of computer 1501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1512 is any type of volatile memory now known or to be developed in the future. Examples include dynamic type random access memory (RAM) or static type RAM. Typically, the volatile memory is characterized by random access, but this is not required unless affirmatively indicated. In computer 1501, the volatile memory 1512 is located in a single package and is internal to computer 1501, but, alternatively or additionally, the volatile memory may be distributed over multiple packages and/or located externally with respect to computer 1501.

PERSISTENT STORAGE 1513 is any form of non-volatile storage for computers that is now known or to be developed in the future. The non-volatility of this storage means that the stored data is maintained regardless of whether power is being supplied to computer 1501 and/or directly to persistent storage 1513. Persistent storage 1513 may be a read only memory (ROM), but typically at least a portion of the persistent storage allows writing of data, deletion of data and re-writing of data. Some familiar forms of persistent storage include magnetic disks and solid state storage devices. Operating system 1522 may take several forms, such as various known proprietary operating systems or open source Portable Operating System Interface type operating systems that employ a kernel. The code included in block 2000 typically includes at least some of the computer code involved in performing the inventive methods.

PERIPHERAL DEVICE SET 1514 includes the set of peripheral devices of computer 1501. Data communication connections between the peripheral devices and the other components of computer 1501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1523 may include components such as a display screen, speaker, microphone, wearable devices (such as goggles and smart watches), keyboard, mouse, printer, touchpad, game controllers, and haptic devices. Storage 1524 is external storage, such as an external hard drive, or insertable storage, such as an SD card. Storage 1524 may be persistent and/or volatile. In some embodiments, storage 1524 may take the form of a quantum computing storage device for storing data in the form of qubits. In embodiments where computer 1501 is required to have a large amount of storage (for example, where computer 1501 locally stores and manages a large database) then this storage may be provided by peripheral storage devices designed for storing very large amounts of data, such as a storage area network (SAN) that is shared by multiple, geographically distributed computers. IoT sensor set 1525 is made up of sensors that can be used in Internet of Things applications. For example, one sensor may be a thermometer and another sensor may be a motion detector.

NETWORK MODULE 1515 is the collection of computer software, hardware, and firmware that allows computer 1501 to communicate with other computers through WAN 1502. Network module 1515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1515 are performed on the same physical hardware device. In other embodiments (for example, embodiments that utilize software-defined networking (SDN)), the control functions and the forwarding functions of network module 1515 are performed on physically separate devices, such that the control functions manage several different network hardware devices. Computer readable program instructions for performing the inventive methods can typically be downloaded to computer 1501 from an external computer or external storage device through a network adapter card or network interface included in network module 1515.

WAN 1502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1503 is any computer system that is used and controlled by an end user (for example, a customer of an enterprise that operates computer 1501), and may take any of the forms discussed above in connection with computer 1501. EUD 1503 typically receives helpful and useful data from the operations of computer 1501. For example, in a hypothetical case where computer 1501 is designed to provide a recommendation to an end user, this recommendation would typically be communicated from network module 1515 of computer 1501 through WAN 1502 to EUD 1503. In this way, EUD 1503 can display, or otherwise present, the recommendation to an end user. In some embodiments, EUD 1503 may be a client device, such as thin client, heavy client, mainframe computer, desktop computer and so on.

REMOTE SERVER 1504 is any computer system that serves at least some data and/or functionality to computer 1501. Remote server 1504 may be controlled and used by the same entity that operates computer 1501. Remote server 1504 represents the machine(s) that collect and store helpful and useful data for use by other computers, such as computer 1501. For example, in a hypothetical case where computer 1501 is designed and programmed to provide a recommendation based on historical data, then this historical data may be provided to computer 1501 from remote database 1530 of remote server 1504.

PUBLIC CLOUD 1505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1505 is performed by the computer hardware and/or software of cloud orchestration module 1541. The computing resources provided by public cloud 1505 are typically implemented by virtual computing environments that run on various computers making up the computers of host physical machine set 1542, which is the universe of physical computers in and/or available to public cloud 1505. The virtual computing environments (VCEs) typically take the form of virtual machines from virtual machine set 1543 and/or containers from container set 1544. It is understood that these VCEs may be stored as images and may be transferred among and between the various physical machine hosts, either as images or after instantiation of the VCE. Cloud orchestration module 1541 manages the transfer and storage of images, deploys new instantiations of VCEs and manages active instantiations of VCE deployments. Gateway 1540 is the collection of computer software, hardware, and firmware that allows public cloud 1505 to communicate through WAN 1502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1506 is similar to public cloud 1505, except that the computing resources are only available for use by a single enterprise. While private cloud 1506 is depicted as being in communication with WAN 1502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1505 and private cloud 1506 are both part of a larger hybrid cloud.

What is claimed is:

1. A computer-implemented system comprising:
a memory that stores computer executable components; and
a processor, operably coupled to the memory, and that executes the computer executable components stored in the memory, wherein the computer executable components comprise:
a generative component that generates an intermediate dataset comprising an inverse copula network, and
a result component that utilizes the intermediate dataset as input for an inverse marginal cumulative distribution function network, resulting in a result dataset of objects, wherein the inverse marginal cumulative distribution function network was generated based on a model dataset of objects.

2. The computer-implemented system of claim 1, wherein generating the intermediate dataset comprises transforming independent uniform noise into correlated uniform noise.

3. The computer-implemented system of claim 1, wherein the inverse marginal cumulative distribution function network was generated based on applying a marginal cumulative distribution function to the model dataset, and wherein the result dataset was generated by applying an inverse of the marginal cumulative distribution function to the intermediate dataset.

4. The computer-implemented system of claim 1, wherein the intermediate dataset corresponds to captured correlations between attributes of the model dataset.

5. The computer-implemented system of claim 2, wherein the result dataset results from applying the inverse marginal cumulative distribution function network to the captured correlations to yield the result dataset that comprises a synthetic dataset that is similar to the model dataset.

6. The computer-implemented system of claim 5, wherein the inverse marginal cumulative distribution function network corresponds to a uniform distribution of captured respective marginal distributions of the model dataset.

7. The computer-implemented system of claim 1, wherein the result dataset comprises a synthetic dataset having a dependence structure and marginal distributions that are similar to the model dataset with a degree of similarity that exceeds a threshold.

8. The computer-implemented system of claim 1, wherein the computer executable components further comprise a discriminator component that performs operations comprising:
generating a discriminator network that classifies the result dataset in relation to the model dataset; and
backpropagating, depending on the classification of the result dataset, changes to the intermediate dataset and the discriminator network, to improve the classifying.

9. The computer-implemented system of claim 8, wherein backpropagating a change to the intermediate dataset comprises accessing the intermediate dataset via the inverse marginal cumulative distribution function network.

10. The computer-implemented system of claim 8, wherein the generative component and the discriminator component are comprised in a generative adversarial network.

11. The computer-implemented system of claim 10, wherein the generative adversarial network comprises a Wasserstein generative adversarial network.

12. The computer-implemented system of claim 11, wherein the generative adversarial network operates by a process that comprises utilizing gradient penalties.

13. The computer-implemented system of claim 8, wherein the computer executable components further comprise:
an extrapolation component that modifies the inverse marginal cumulative distribution function network, resulting in a modified inverse marginal cumulative distribution function network, wherein the result component utilizes the intermediate dataset as input for the modified inverse marginal cumulative distribution function network, and wherein, based on the result dataset being generated by the modified inverse marginal cumulative distribution network, the result dataset comprises synthetic data generated by extrapolation beyond the model dataset of objects.

14. The computer-implemented system of claim 13, wherein the extrapolation component modifies the inverse marginal cumulative distribution function network based on an association between a different dataset of the objects, and wherein the synthetic data results from extrapolation from the model dataset to the different dataset.

15. The computer-implemented system of claim 14, wherein the different dataset comprises a non-tail portion of the model dataset and the synthetic data comprises extrapolated data that describes a tail portion of the model dataset.

16. A computer-implemented method, comprising:
generating, by a device operatively coupled to a processor, ones an intermediate dataset comprising an inverse copula network, and
utilizing, by the device, the intermediate dataset as input for an inverse marginal cumulative distribution function network, resulting in a result dataset of objects, wherein the inverse marginal cumulative distribution function network was generated based on a model dataset of objects.

17. The computer-implemented method of claim 16, wherein the intermediate dataset corresponds to captured correlations between attributes of the model dataset.

18. The computer-implemented method of claim 16, wherein the result dataset results from applying an inverse of the marginal cumulative distribution function to the captured correlations to yield a synthetic dataset that is similar to the model dataset.

19. A computer program product that generates a synthetic dataset of objects, the computer program product comprising a computer readable storage medium having program instructions embodied therewith, the program instructions executable by a processor to cause the processor to:
generate an inverse copula network;
utilize the inverse copula network as input for an inverse marginal cumulative distribution function network, resulting in the synthetic dataset of objects, wherein the inverse marginal cumulative distribution function network was generated based on a model dataset of objects;
generate a discriminator network that classifies the synthetic dataset in relation to the model dataset; and
to improve the classifying, backpropagating, depending on the classification of the result dataset, changes to the inverse copula network and the discriminator network.

20. The computer program product of claim 19, wherein the inverse copula network corresponds to captured correlations between attributes of the model dataset.
